(19) United States
(12) Patent Application Publication
(10) Pub. No.: US 2011/0187521 A1
(43) Pub. Date: Aug. 4, 2011

(54) TACTILE DRIVER FEEDBACK REGARDING THE OPERATIONAL READINESS OF A VEHICLE

(75) Inventors: Cornelia Beruscha, Vaihingen/Enz (DE); Bernd Peichl, Marbach Am Neckar (DE); Herbert Prickarz, Fellbach (DE)

(73) Assignee: ROBERT BOSCH GMBH, Stuttgart (DE)

(21) Appl. No.: 13/001,285

(22) PCT Filed: Apr. 30, 2009
(86) PCT No.: PCT/EP2009/055268

§ 371 Date: Apr. 19, 2011

(30) Foreign Application Priority Data
Jul. 3, 2008 (DE) 10 2008 040 113.7

(51) Int. Cl. H04B 3/36; B60Q 1/00

(52) U.S. Cl. 340/441; 903/903

(57) ABSTRACT

A method is described for generating a tactile driver feedback regarding the operational readiness of a vehicle, in particular a hybrid vehicle, the feedback being generated as a function of the state of a drive train of the vehicle.

### FIELD OF THE INVENTION

The present invention relates to a method for generating a tactile driver feedback regarding the operational readiness of a vehicle, in particular a hybrid vehicle.

### BACKGROUND INFORMATION

Modern vehicles, owing to the extreme quietness of their operation and their very good insulation from noises and/or vibrations of the drive train, provide the driver with very little or no feedback concerning their operational readiness. In particular, in the case of hybrid vehicles running on their electric motor, their operational readiness is not necessarily evident to the driver. While after operating a starter button or an ignition key the vehicle is ready for operation, this operational readiness is not necessarily evident to the driver, in particular if, with a hybrid vehicle's high-voltage battery pack at a high level of charge, the internal combustion engine of the hybrid vehicle is not in use but the vehicle will be driven off using the electric motor alone and will then be operated purely electrically. In particular in this phase of putting the vehicle into operation, a representational display, or a display of purely visual indicators, such as telltale lamps, is often insufficient to make the driver adequately aware that the vehicle is ready for operation, in particular if the driver is in a stressful situation, for example, or is inattentive. In such a case the driver is not informed with sufficient clarity of the actual state of his vehicle, and in particular of whether he may drive off simply by pressing the accelerator/drive pedal.

German Patent document DE 10 2004 047545 A1 discusses a haptic driver feedback on the steering device for giving a warning to the driver.

### SUMMARY OF THE INVENTION

It is advantageous for the driver to be provided with a tactile feedback concerning the operational readiness of his vehicle, informing him of its operational state without requiring that he direct particular attention to the matter.

To this end a method for generating a tactile driver feedback regarding the operational readiness of a vehicle, in particular a hybrid vehicle, is proposed, with the feedback being generated as a function of the state of a drive train of the vehicle. The operational readiness of the vehicle, in the sense of its readiness to drive away, is decisively affected by the state of the drive train of the vehicle, in particular by whether driving power will be available when the driver makes a torque request.

In one embodiment of the method the driver feedback is communicated by vibration. Vibration-based communication is in the widest sense that of which the driver becomes aware through vibration, in other words through changes in position, detectable actively and passively, of at least one object in the vicinity. In particular, such vibrations may be not only haptic, in the sense of being actively detected by the driver, which requires the active involvement of the motor cortex, but may in particular be such as may be sensed through reception of passive stimuli. This significantly widens the range of the tactile communications that may be utilized, while in particular requiring no active, still less directed, attention nor any active behavior on the part of the driver. Whereas haptic detection actually includes an active detection, in the sense of running fingers over surfaces, or pressing, grasping or following shapes, in the detection of passive stimuli, such as for example being touched or being shaken, the sensory apparatus of the human body, not actively engaged by the driver, is sufficient to draw his attention to a given situation.

In a further embodiment of the method, the driver feedback is an acoustic communication. An acoustic communication is in the widest sense also a vibration-based communication or includes a vibration-based communication, provided that the vibration occurs at least in part in a frequency range detectable by the human sense of hearing, or generates frequencies detectable by humans. Acoustic reception, like the reception of a general vibration-based communication, is non-directional, in other words does not require that the driver look in a particular direction, as is required in the case of a visual communication.

One form of the acoustic communication is a modulated engine noise. The engine noise is either stored or else artificially generated, and in particular also modulated as to volume and changes in frequency, thereby giving the driver the sense of a normal internal combustion engine. As a matter of habit, the driver associates his sensing of a normal internal combustion engine, in particular of an engine that is starting up, with the vehicle's readiness for operation, and in particular the readiness of the drive train to provide propulsion to the vehicle.

The driver feedback may be supplied to an item of the vehicle's equipment that is in contact with the driver. This may be any of the parts of the vehicle's equipment that touch the driver. In particular this will include those that the driver intentionally grasps and also those that he touches in some other way, including unintentionally and without taking specific action.

For example, in one embodiment of the method the part of the vehicle's equipment used may be the steering wheel, while in another embodiment of the method the part of the vehicle's equipment used may alternatively or additionally be a seat, in particular a driver's seat. The embodiment of the method using the driver's seat is advantageous in particular, because the driver is accustomed to drawing conclusions from stimuli transmitted through and/or by means of his seat as to the state of the vehicle, the road and certain processes of motion.

In one embodiment of the method, the driver feedback is a continuously acting communication. It is thus taking place all the time. In another embodiment of the method, the driver feedback is a communication limited in duration, in other words one that is only given for a certain period of time. The duration may be of any length. In particular it is also possible to convert an initially continuous communication into one lasting only a certain duration, or to replace it by communications of limited duration, upon occurrence of certain events, for example an appropriate acknowledgment by the driver or when the vehicle begins to move.

In another embodiment of the method, the driver feedback is a communication repeated at certain intervals, in particular periodically. This method makes it very advantageously possible that the driver is reminded at certain intervals, in particular periodically, of the operational readiness of the vehicle. This is particularly advantageous when the vehicle is stationary for long periods, for example at a red traffic light, at closed railroad crossings, or in a traffic jam. By means of such repeated communications the driver is reminded of the operational readiness of his vehicle and is prevented, for example, from incautiously getting out of the vehicle. In addition, this reminder may cause the driver to switch off the vehicle's engine to save energy.

An important feature, in addition, is that the driver feedback may be generated by the vehicle without involvement of any special detection unit making use of sensors, for example, to detect vehicle states or surrounding conditions. On the contrary, it is possible to initiate the driver feedback directly by way of the vehicle's control unit, approximately in the way that a display or some other visual message is generated to indicate the operational readiness of the vehicle, for example in hybrid vehicles.

Other advantageous specific embodiments are derived from the descriptions herein and from combinations thereof.

The present invention is explained in greater detail below on the basis of an exemplary embodiment, without however being restricted hereupon.

### BRIEF DESCRIPTION OF THE DRAWING

The FIGURE shows a vehicle together with a device and a method for generating a tactile driver feedback.

### DETAILED DESCRIPTION

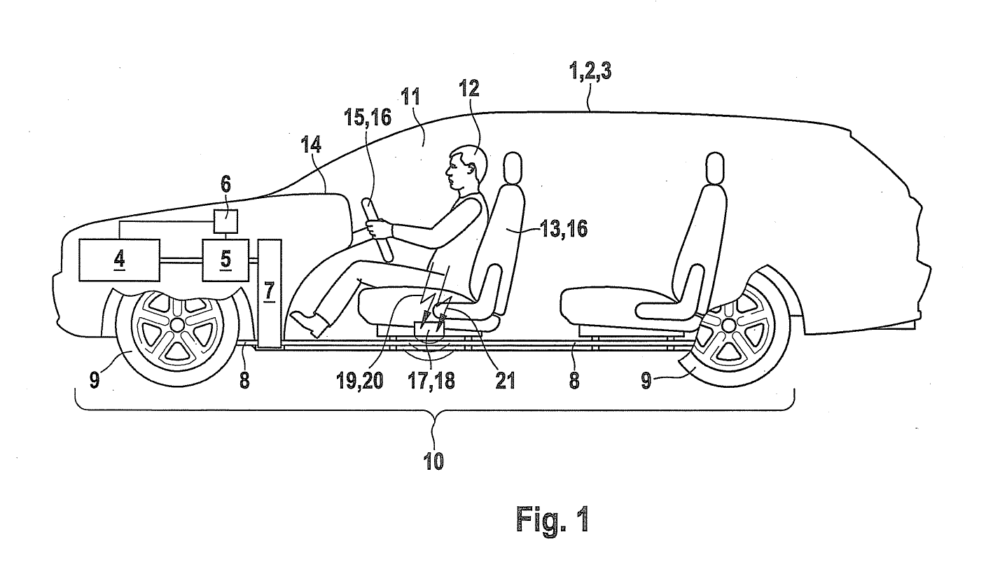

FIG. 1 shows vehicle 1, in particular motor vehicle 2, in the form of hybrid vehicle 3 powered by internal combustion engine 4 and electric motor 5, internal combustion engine 4 and electric motor 5 being controlled and switched between their operational states by control unit 6 or by an array of control units and deliver their mechanical output through transmission 7 and drive shafts 8 to wheels 9 in order to propel the vehicle.

Internal combustion engine 4, electric motor 5, transmission 7, drive shafts 8 and wheels 9 form drive train 10.

Vehicle 1 has passenger compartment 11 to accommodate driver 12 and other occupants, not shown, and/or loads. Driver's seat 13 is provided for driver 12, and is placed in the normal location in front of dashboard 14 and steering wheel 15. Motor vehicle 2 may be propelled by internal combustion engine 4, electric motor 5 or both, the selection among the modes being made by control unit 6 as a function of the state of charge of the batteries, not shown, for electric motor 5. Alternatively or additionally, the selection between the propulsive modes may also be made by driver 12.

When drive train 10 is ready for operation, in other words when propulsion is supplied to wheels 9 by at least internal combustion engine 4 or electric motor 5, driver 12 may, by pressing, for example, an accelerator pedal, not shown, send a torque request to control unit 6, whereupon the latter, through transmission 7 and either internal combustion engine 4 or electric motor 5 or alternatively both, converts the torque request into a rotary movement of wheels 9 and thus sets vehicle 1 in motion. In particular when vehicle 1 is operated by electric motor 5, driver 12 does not detect the patterns of noise and/or vibration that are usual for internal combustion engine 4, and in consequence in unfavorable situations or in the case of severe inattention on the part of driver 12 it may be unclear to him what is the state of drive train 10, and in particular whether the vehicle will react to a torque request, in other words whether the vehicle is ready for operation. For this reason a signaling device 17 is situated under driver's seat 13 as an item of the vehicle's equipment 16, in particular a vibration device 18, that is linked with control unit 6 by suitable connecting wires, not shown. The state of drive train 10 is communicated to vehicle equipment 16.

When the operational readiness of drive train 10, in particular following a restart of electric motor 5, is provided to control unit 6, which has the role of controlling and switching internal combustion engine 4 and electric motor 5, vibration device 18 under driver's seat 13 is activated via the appropriate electrical connections, not shown, so that driver feedback 19 is applied to driver 12 by vibration device 18 or, alternatively, by signaling device 17 via vehicle equipment 16, specifically driver's seat 13. Driver 12 thus detects, by means of his sitting in driver's seat 13, driver feedback 19 through the vibration of vibration device 18, thereby becoming aware that drive train 10 is in an operationally ready state. Alternatively or additionally, steering wheel 15 may also be used as a further item of vehicle equipment 16, acting by way of signaling device 17 or a further signaling device 17 (not shown here with reference to steering wheel 15) to generate driver feedback 19.

In particular it may be provided that driver feedback 19 is provided periodically, in other words at essentially identical intervals, for a specified duration, in order to give driver 12 regular feedback on the operational readiness of drive train 10 for setting vehicle 1 in motion.

Here the driver feedback takes the form of vibration-based communication 20. This has the advantage that it may be detected by driver 12 even unintentionally and without his paying specific attention. It also has the advantage that it may be designed in such a way that it is similar or identical to the sensations coming from conventionally propelled vehicles equipped with internal combustion engine 4 and habitually detected when operating a hybrid vehicle running on internal combustion engine 4. Thus driver 12 has no need to learn the system and needs no time to get used to it.

Driver feedback 19 may additionally also be an acoustic communication 21, and in that case both vibration-based communication 20 and acoustic communication 21 may be present as alternatives or in conjunction, or may be combined with other communications, not shown, in particular visual signals, for example by way of displays, not shown, on dashboard 14 or other suitable devices.

1-12. (canceled)

13. A method for generating a tactile driver feedback regarding an operational readiness of a vehicle, which is a hybrid vehicle, the method comprising:
determining a state of a drive train of the vehicle; and
generating the tactile driver feedback as a function of the state of the drive train of the vehicle.

14. The method of claim 13, wherein the driver feedback is a vibration-based communication.

15. The method of claim 13, wherein the driver feedback is an acoustic communication.

16. The method of claim 15, wherein the acoustic communication is a modulated engine noise.

17. The method of claim 13, wherein the driver feedback is supplied to a part of the vehicle's equipment that is in contact with the driver.

18. The method of claim 17, wherein the piece of vehicle equipment used is a steering wheel.

19. The method of claim 17, wherein the piece of vehicle equipment used is a seat, in particular a driver's seat.

20. The method of claim 13, wherein the driver feedback is a continuous communication.

21. The method of claim 13, wherein the driver feedback is a communication that is limited in duration.

22. The method of claim 13, wherein the driver feedback is a communication repeated at certain intervals or periodically.

23. A device for generating a tactile driver feedback regarding an operational readiness of a vehicle, which is a hybrid vehicle, comprising:
a determining arrangement to determine a state of a drive train of the vehicle; and
a generating arrangement to generate the tactile driver feedback as a function of the state of the drive train of the vehicle.

24. The device of claim 23, wherein an operational readiness of the vehicle is ascertained by determining the state of the drive train of the vehicle.
